(19) United States
(12) Patent Application Publication
(10) Pub. No.: US 2001/0048867 A1
(43) Pub. Date: Dec. 6, 2001

(54) Method and apparatus for processing semiconductor wafers

(75) Inventors: Tony Lebar, Santa Clara, CA (US); Han K. Lie, San Jose, CA (US); Hyop S. Rhee, Saratoga, CA (US); Janice I. McOmber, Redwood City, CA (US)

Correspondence Address: Edward S. Wright, FLEHR HOHBACH TEST, ALBRITTON & HERBERT LLP, Four Embarcadero Center, Suite 3400, San Francisco, CA, 94111, US

(73) Assignee: Lebar Technology, Inc.

(21) Appl. No.: 09/820,544

(22) Filed: Mar. 28, 2001

Related U.S. Application Data
(60) Provisional application No. 60/193,063, filed on Mar. 29, 2000.

(51) Int. Cl. B65G 1/00

(52) U.S. Cl. 414/217

(57) ABSTRACT

Method and apparatus for processing semiconductor wafers in a vacuum chamber in which a plurality of wafers are stored in a cassette outside the chamber, wafers are transferred between the cassette and a staging station inside the chamber with a transfer mechanism located outside the chamber, and wafers are transferred between the staging station and a processing station within the chamber with a transfer mechanism located inside the chamber. In some embodiments, the staging station moves back and forth between the processing chamber and a load lock, with a closure connected to the staging station sealing off the processing chamber when the staging station is in the load lock and wafers are being transferred between the staging station and the cassette.

This is based upon Provisional Application No. 60/193,063, filed Mar. 29, 2000.

This invention pertains generally to the processing of semiconductor wafers and, more particularly, to a method and apparatus for transferring wafers into and out of a vacuum chamber for processing either in a random fashion or in a sequential fashion.

Vacuum processing chambers are utilized in a wide variety of Wafer processing applications such as plasma etching, stripping, ashing and surface modification, plasma immersion implantation, and chemical vapor deposition (CVD) processes. In order to maintain the vacuum while wafers are being loaded and unloaded, such systems usually have load locks and expensive robots between the load locks and the processing chambers.

It is in general an object of the invention to provide a new and improved method and apparatus for processing semiconductor wafers.

Another object of the invention is to provide a method and apparatus of the above character which do not require expensive load locks and robots for loading wafers into and out of a processing chamber.

These and other objects are achieved in accordance with the invention by providing a method and apparatus for processing semiconductor wafers in a vacuum chamber in which a plurality of wafers are stored in a cassette outside the chamber, wafers are transferred between the cassette and a staging station inside the chamber with a transfer mechanism located outside the chamber, and wafers are transferred between the staging station and a processing station within the chamber with a transfer mechanism located inside the chamber. In some embodiments, the staging station moves back and forth between the processing chamber and a load lock, with a closure connected to the staging station sealing off the processing chamber when the staging station is in the load lock and wafers are being transferred between the staging station and the cassette.

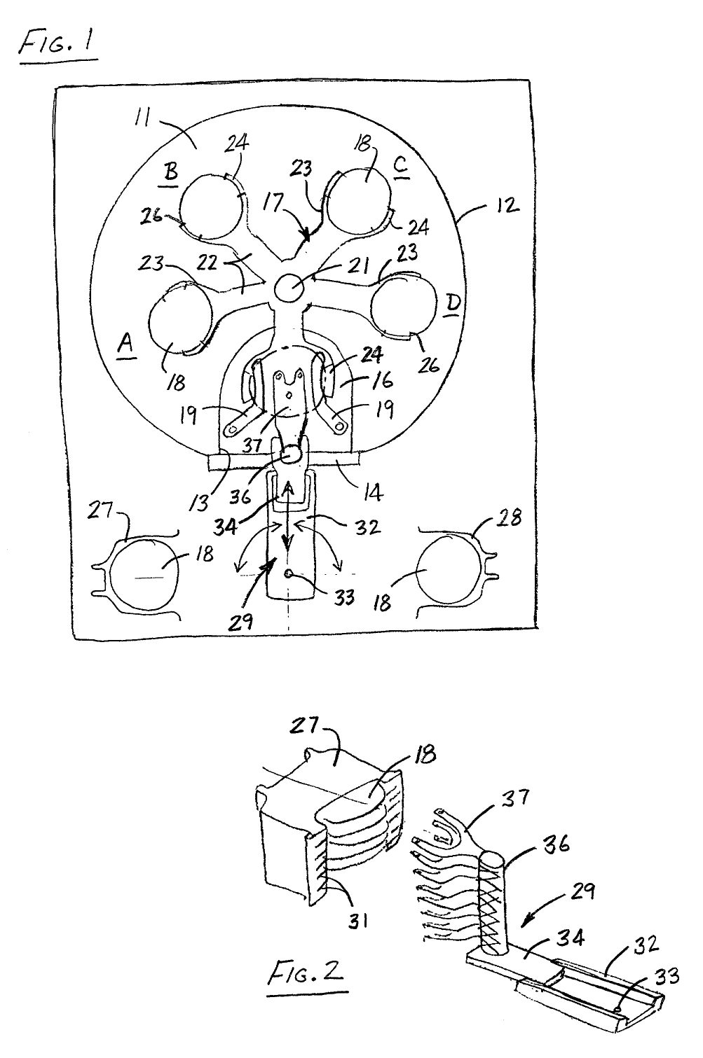

FIG. 1 is a top plan view, somewhat schematic, of one embodiment of wafer processing apparatus incorporating the invention.

FIG. 2 is an isometric view of the wafer loader and one of the cassettes in the embodiment of FIG. 1.

FIG. 3 is a top plan view of the staging station in the embodiment of FIG. 1.

FIGS. 4 - 7 are operational views of one embodiment of a wafer carrier for use in the embodiment of FIG. 1.

FIGS. 8 - 9 are fragmentary top plan views of another embodiment of a wafer carrier for use in the embodiment of FIG. 1.

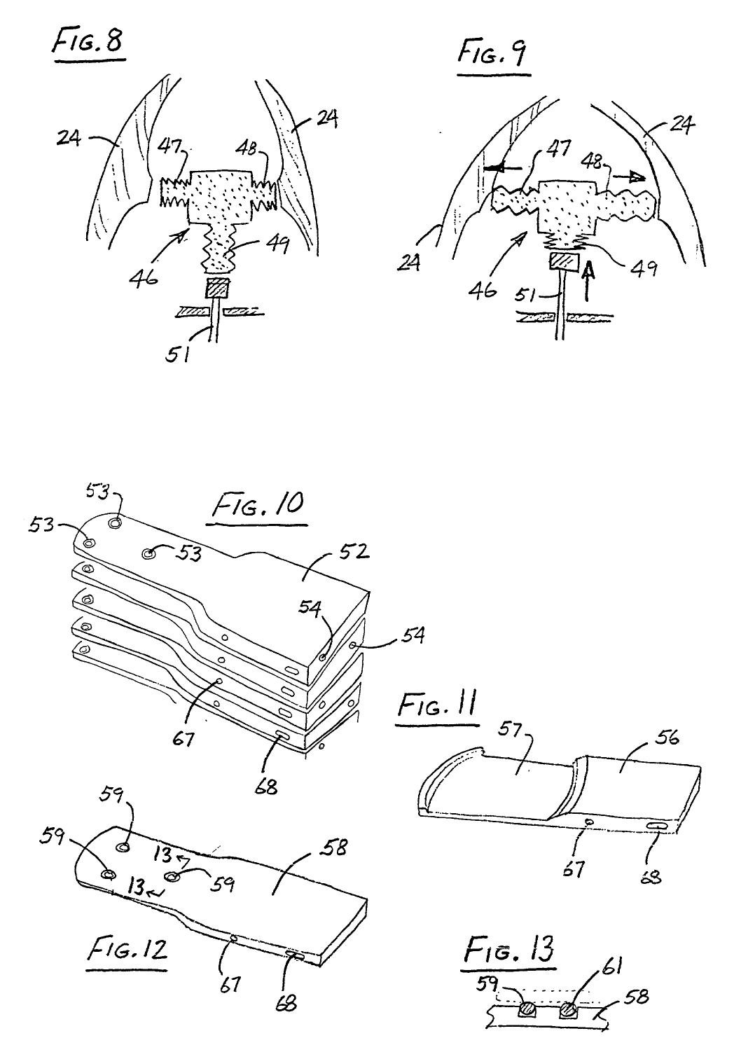

FIG. 10 is an isometric view of a stack of wafer carrying paddles for use in the embodiment of FIG. 1.

FIGS. 11 - 12 are isometric views of other embodiments of wafer carrying paddles for use in the embodiment of FIG. 1.

FIG. 13 is a cross-sectional view taken along line 13 - 13 in FIG. 12.

FIG. 14 is a side elevational view of one embodiment of a wafer carrier with adjustable wafer spacing for use in the embodiment of FIG. 1.

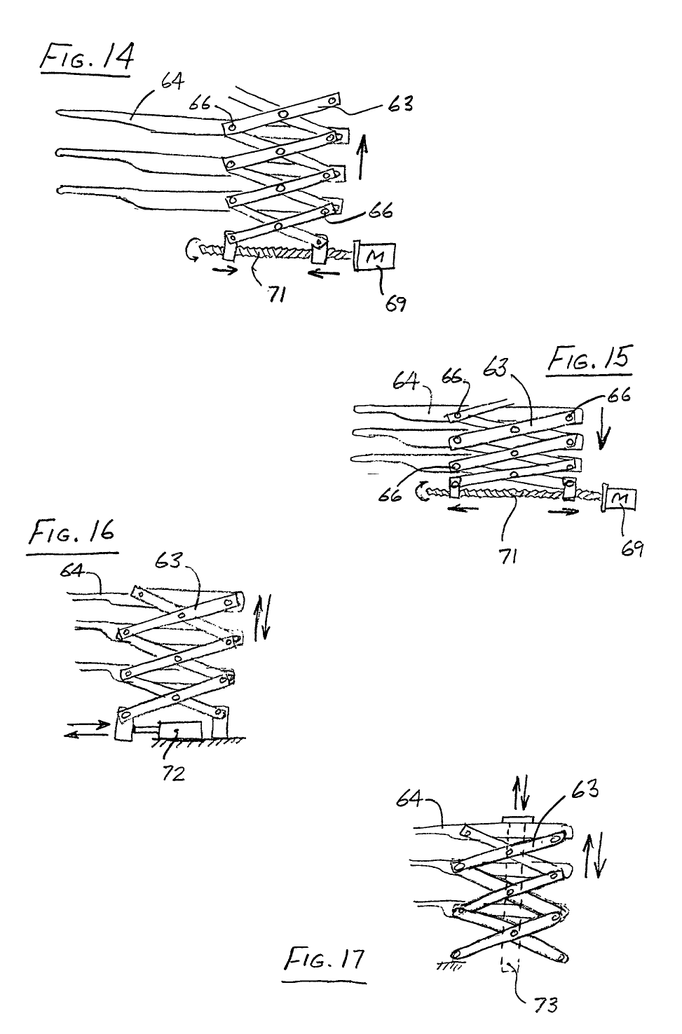

FIG. 15 is a view similar to FIG. 14, illustrating the wafer carrier in a different operative position.

FIGS. 16 - 17 are side elevational views of additional embodiments of wafer carriers with adjustable wafer spacing for use in the embodiment of FIG. 1.

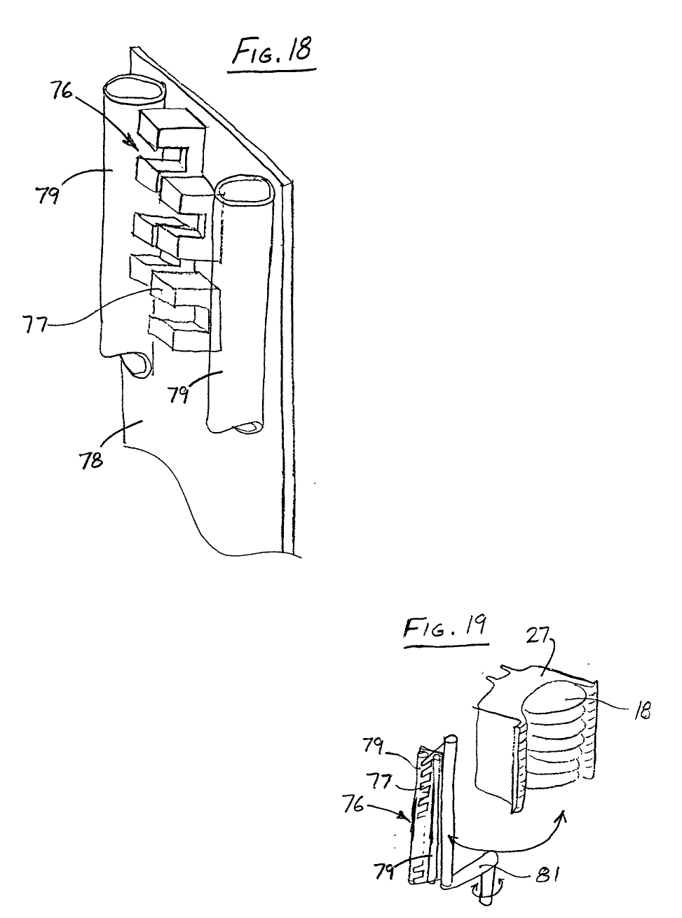

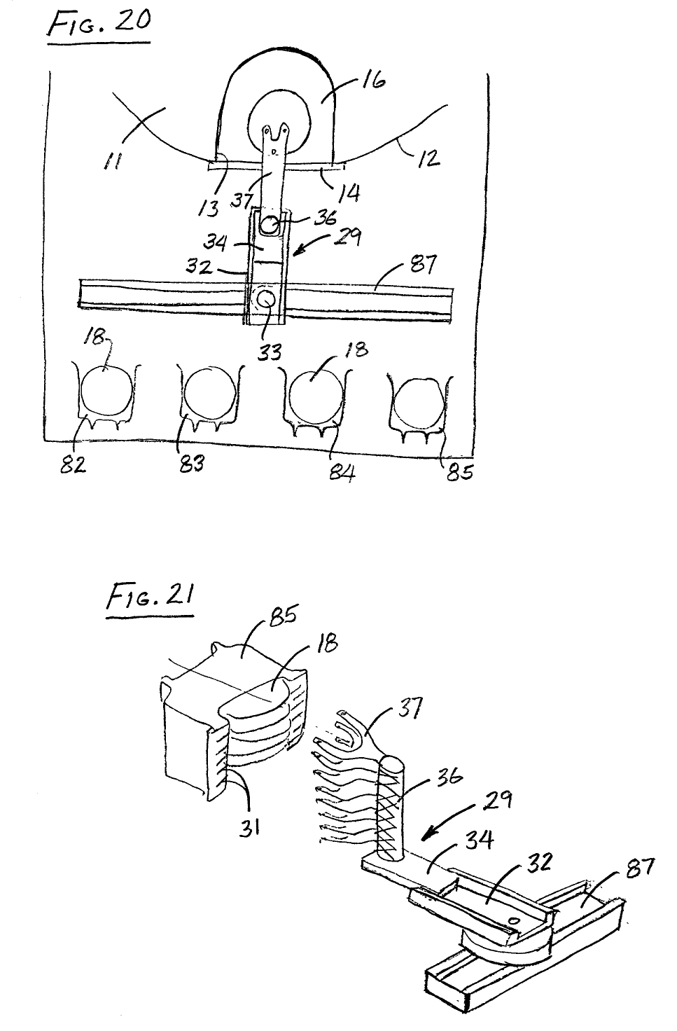

FIG. 18 is an isometric view of one embodiment of a sensor for mapping wafers for use in the embodiment of FIG. 1.

FIG. 19 is an operational view of the embodiment of FIG. 18.

FIG. 20 is a fragmentary top plan view, somewhat schematic, of another embodiment of wafer processing apparatus incorporating the invention.

FIG. 21 is an isometric view of the wafer loader and one of the cassettes in the embodiment of FIG. 20.

FIGS. 22 - 23 are fragmentary top plan views, somewhat schematic, of additional embodiments of wafer processing apparatus incorporating the invention.

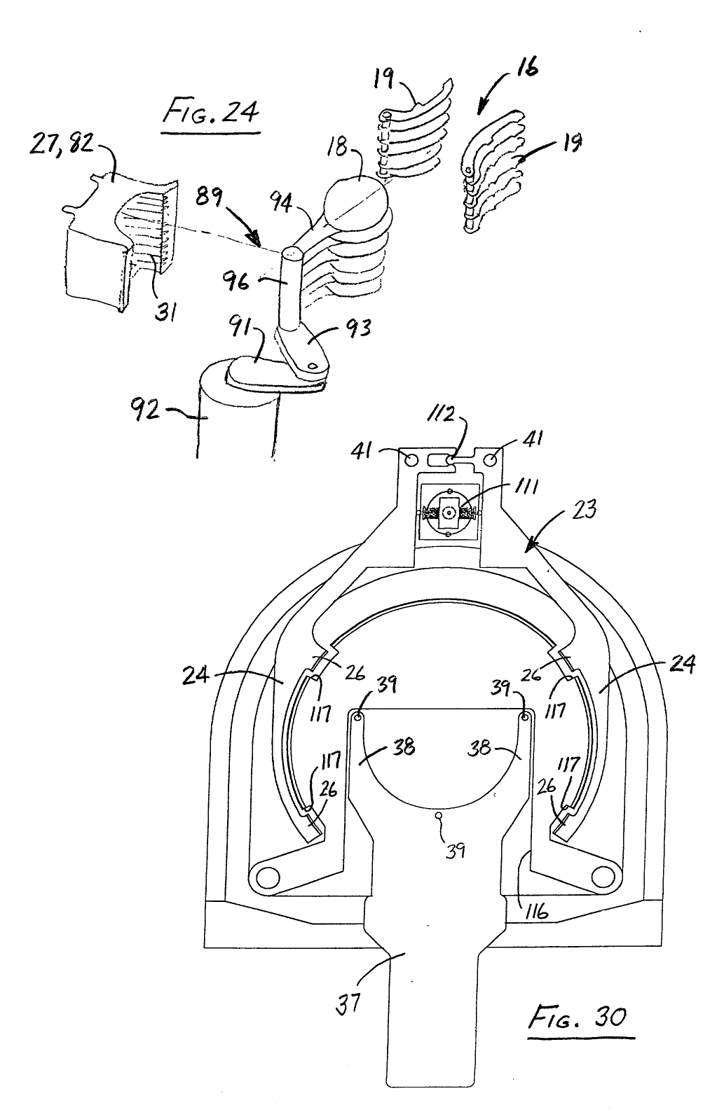

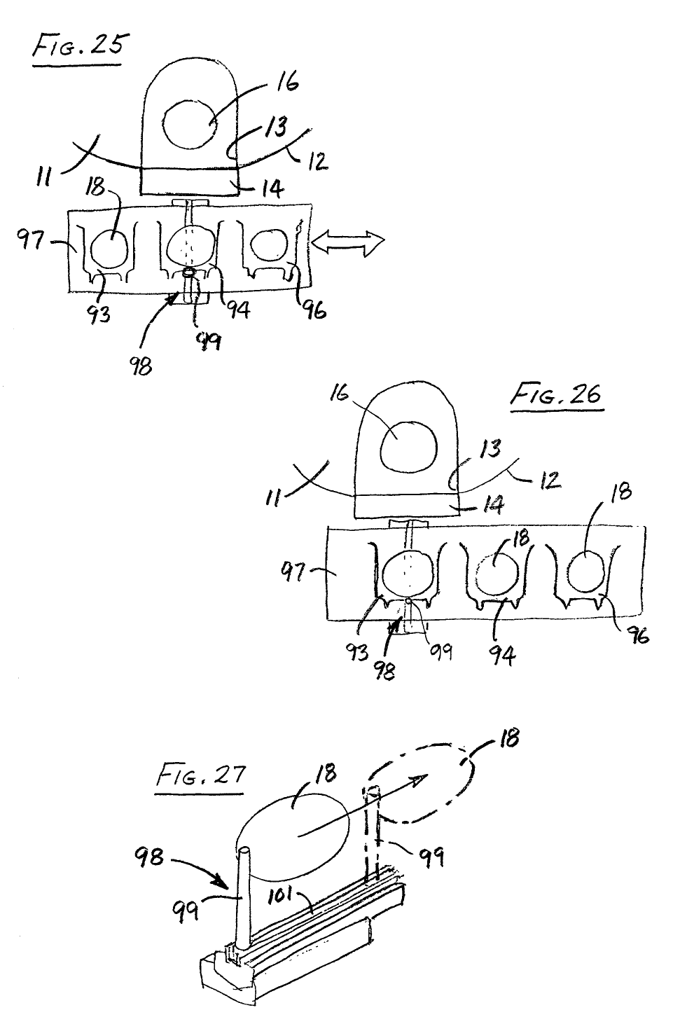

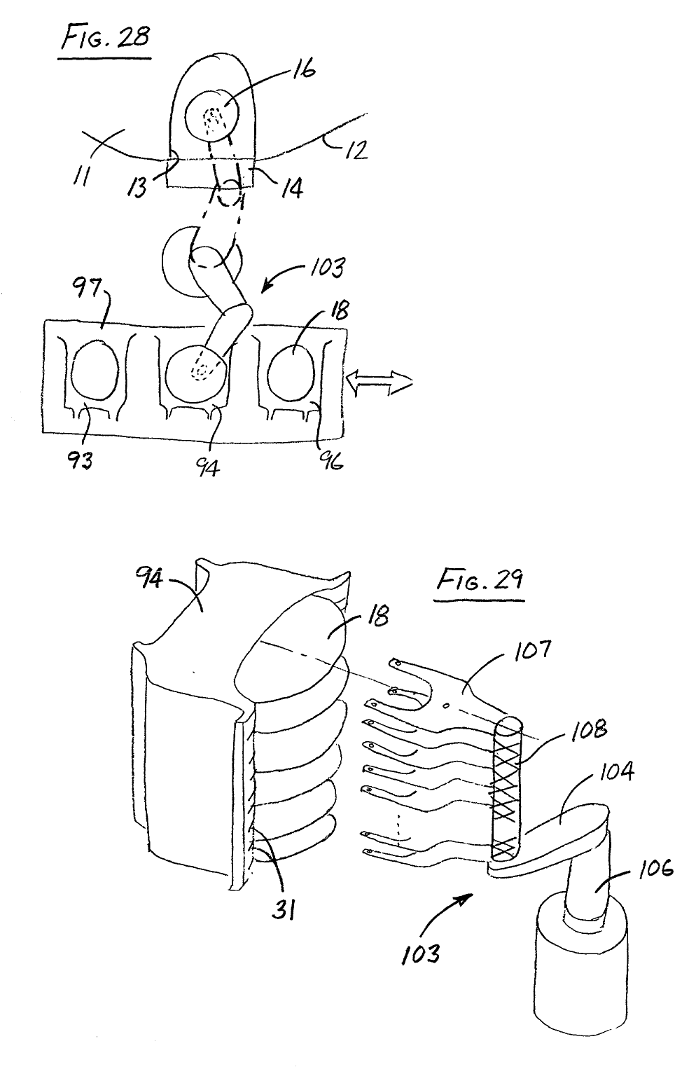

FIG. 24 is an isometric view of the wafer loader with one of the cassettes and the staging shelves in the embodiments of FIGS. 22 - 23.

FIG. 25 is a fragmentary top plan view, somewhat schematic, of another embodiment of wafer processing apparatus incorporating the invention.

FIG. 26 is a view similar to FIG. 25, showing the apparatus in a different operative position.

FIG. 27 is an isometric view of the wafer pusher in the embodiment of FIG. 26.

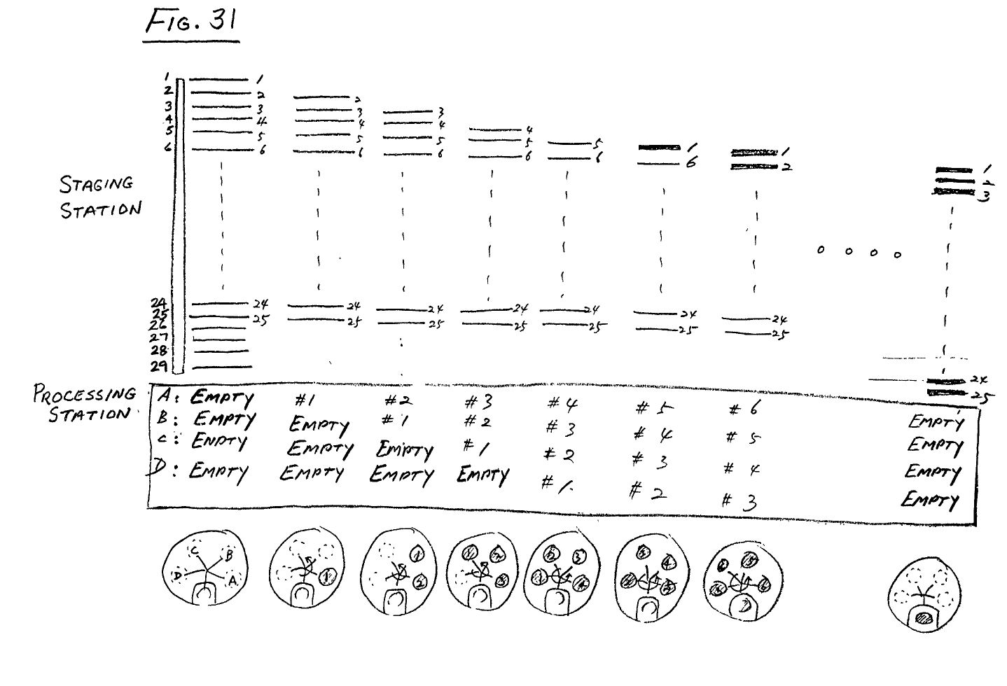

FIG. 28 is a fragmentary top plan view, somewhat schematic, of another embodiment of wafer processing apparatus incorporating the invention.

FIG. 29 is an isometric view of the wafer loader and one of the cassettes in the embodiment of FIG. 28.

FIG. 30 is a top plan view of another embodiment of a staging station for use wafer processing apparatus according to the invention.

FIG. 31 is a chart illustrating sequential processing of wafers in accordance with the invention.

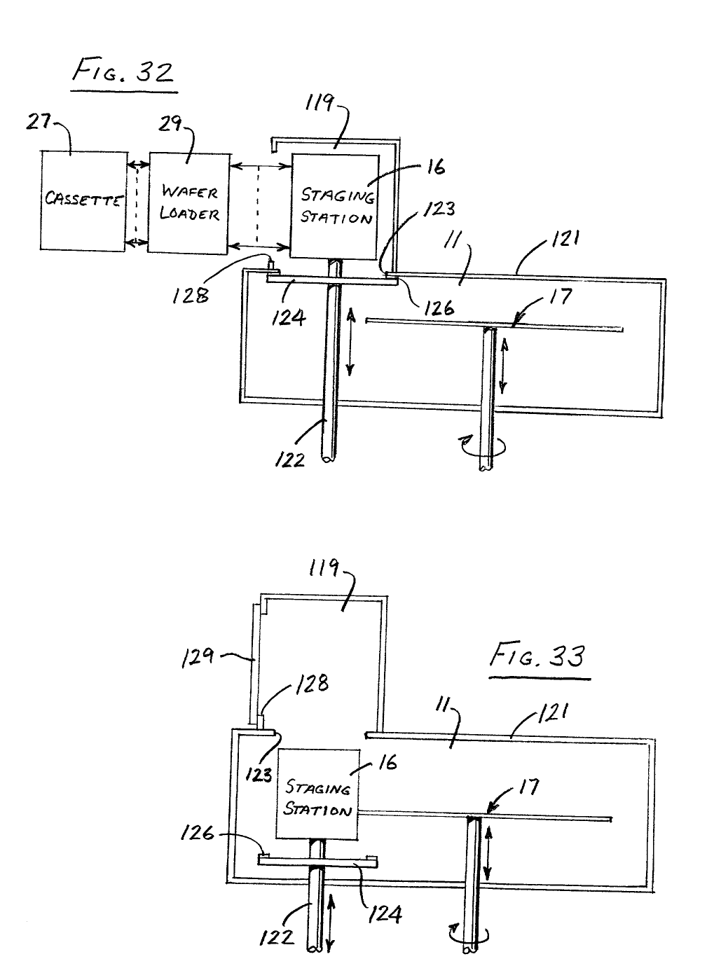

FIG. 32 is a vertical sectional view, somewhat schematic, of another embodiment of wafer processing apparatus incorporating the invention.

FIG. 33 is a view similar to FIG. 32, showing the apparatus in a different operative position.

As illustrated in FIG. 1, the wafer processing apparatus includes a vacuum chamber 11 which has a generally cylindrical side wall 12 with an access opening 13 in the side wall and a door 14 for closing the opening.

Within the vacuum chamber, there are a wafer staging station 16, a plurality of wafer processing stations A - D, and a turret 17 for transferring wafers 18 between the staging station and the processing stations. Although four processing stations are shown in this particular embodiment, any suitable number can be provided.

The staging station is located near the access door, and has a plurality of vertically stacked, horizontally extending shelves 19 for receiving wafers that are being transferred into and out of the vacuum chamber. The number of shelves in the staging station is preferably at least the number of wafers which can be transferred into and out of the chamber at a time, plus the number of processing stations in the chamber. Thus, for example, if 25 wafers are transferred at a time, then the staging station would have at least 29 shelves.

The turret is a simple lift and rotate mechanism comprising a vertically extending shaft 21 and a plurality of radially extend arms 22, with wafer carriers 23 at the outer ends of the arms. The shaft can be moved axially as well as being rotated in order to access the shelves at different heights in the staging station. The shaft is preferably driven by a magnetic coupling through the chamber wall to avoid the need for a vacuum seal on the shaft. Alternatively, however, it can be driven mechanically, in which case it will pass through a vacuum seal in the lower wall of the processing chamber. The staging station and the processing stations are located on a circular path which is centered about the axis of the shaft, with no vacuum door or wall separating them.

Each of the wafer carriers 23 has a pair of arcuate fingers 24, with radially extending tabs 26 on which the wafers can rest. As discussed more fully hereinafter, the fingers can be moved between closed and open positions for picking up and releasing the wafers.

Wafers are transferred into and out of the vacuum chamber from cassettes 27, 28 by means of a wafer transfer mechanism or robot 29. Both the cassettes and the robot are located outside the vacuum chamber at atmospheric pressure. The cassettes have vertically spaced, horizontally extending slots 31 for receiving the wafers, and in this particular embodiment, the cassettes are positioned on opposite sides of the access door, facing each other, with the robot between them.

Robot 29 has a carriage 32 that pivots about an axis 33 which is located on the centerline between the cassettes and directly in front of the access door. A slide 34 is mounted on the carriage for transnational movement. It includes an upstanding post 36 with a plurality of horizontally extending paddles 37 for carrying the wafers. In this particular embodiment, the paddles are fork-like elements with tines 38 and pads 39 on which the wafers can rest. The tines are fixed, and the paddles are raised and lowered relative to the cassettes and transfer station 16 to engage and disengage the wafers. This can be done either by movement of the robot or by moving the cassettes and the transfer station up and down. The number of paddles corresponds to the number of slots in the cassettes, e.g. 25, so that all of the wafers in a cassette transferred at once.

Although the wafers are shown as being stacked horizontally in this particular embodiment, they can be stacked horizontally or positioned side-by-side, if desired.

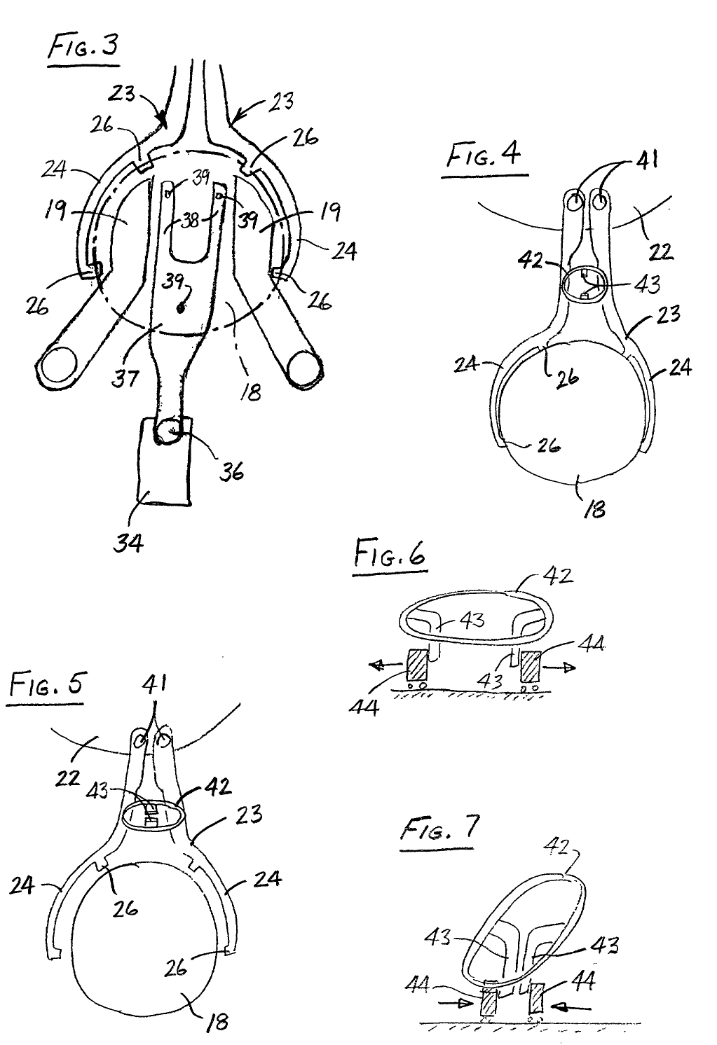

As indicated above, the fingers 24 of wafer carriers 23 can be moved between closed and open positions for engagement with and disengagement from the wafers. As illustrated in FIGS. 4 - 5, the inner ends of the fingers are attached to the outer ends of turret arms 22 by pivots 41 so that the arcuate portions of the fingers can move toward and away from each other. In this particular embodiment, the fingers are moved between the open and closed positions by a resilient ring 42 with diametrically opposed tabs 43 and actuators 44. In the rest position, the ring is circular, and the fingers are held together in the closed position, as illustrated in FIG. 4. Squeezing the tabs together causes the ring to elongate, pushing the fingers apart, as illustrated in FIGS. 5 and 7.

FIGS. 8 and 9 illustrate an alternate embodiment which has a bellows assembly 46 for moving the fingers. In this embodiment, the fingers 24 are biased toward the closed the closed position by a spring or other suitable resilient means (not shown). The bellows assembly has three bellows members 47 - 49 in fluid communication with each other, with an actuator 51 for pushing against one of them. The bellows members are arranged in a T-shaped configuration, with bellows members 47, 48 bearing against the inner sides. With the fingers in the closed position, bellows members 47, 48 are compressed, and bellows member 49 is extended, as illustrated in FIG. 8. When the actuator presses against bellows member 49 and compresses it, bellows members 47, 48 expand and push the fingers apart, as illustrated in FIG. 9.

FIGS. 10 - 14 illustrate alternative embodiments of paddles for use transferring wafers between the cassettes and the staging station. In the embodiment of FIG. 10, paddles 52 have vacuum pads 53 are arranged in a triangular pattern on their upper sides for engagement with the wafers. Vacuum passageways 54 communicate with the pads and open through the inner ends of the paddles for connection to vacuum lines (not shown). The passageways are staggered on successive paddles in the stack to facilitate connection of the vacuum lines.

In the embodiment of FIG. 11, each of the paddles 56 has a recessed area 57 toward its outer end for receiving the wafers.

In the embodiment of FIGS. 12 - 13, each of the paddles 58 has O-ring pads 59 arranged in a triangular pattern for engagement with the wafers. These O-rings are mounted in annular grooves 61 in the upper surfaces of the paddles, and they hold the wafers in place by friction.

If the spacing between the slots in the cassettes and the shelves in the staging station is not the same, the transfer mechanism includes means for changing the spacing between the wafers as it transfers them. As illustrated in FIG. 14, this means includes a scissors mechanism 63 on which the wafer carrying paddles 64 are mounted. The paddles can, for example, be any of the types shown in FIGS. 10 - 12, and they are connected to the links and held in a horizontal position by pins 66. The pins are received in mounting holes 67, 68 in the sides of the paddles, with holes 68 being elongated to allow the pins in them to shift horizontally and maintain the paddles parallel to each other as the mechanism expands and contracts.

The scissor mechanism is driven by a drive motor 69 and a lead screw 71 which engages oppositely threaded nuts 72 at the lower end of the mechanism. Rotating the screw in one direction draws the nuts together and extends the mechanism, thereby increasing the spacing between the paddles, as illustrated in FIG. 14. Rotating the screw in the opposite direction separates the nuts and collapses the mechanism, thereby decreasing the spacing between the paddles, as shown in FIG. 15.

The embodiment of FIG. 16 is similar to the embodiment of FIG. 15 except it has an air cylinder 72 connected to the lower end of the mechanism for extending and collapsing it.

Alternatively, the actuator 73 can extend vertically of the scissors mechanism, as illustrated in FIG. 17. It can be an air cylinder, a lead screw or any other suitable device for extending and collapsing the linkage. In this embodiment, the actuator is connected to the uppermost paddle in the stack.

The system also includes a wafer mapping sensor assembly 76 for mapping wafers in the cassettes. As illustrated in FIG. 18, this assembly includes a plurality of sensors 77 which are stagger mounted in two vertically extending rows on a base plate 78. Vertically extending pusher bars 79 are mounted on the plate on either side of the sensors for aligning the wafers in the cassettes prior to mapping. These bars are fabricated of a clean, flexible material such as Teflon tubing which will not contaminate or damage the wafers.

As illustrated in FIG. 19, the sensor assembly is mounted on a swing arm or crank 81 for movement into and out of engagement with the wafers 18 in cassette 27.

Operation and use of the wafer processing apparatus, and therein the method of the invention are as follows. To transfer wafers into the chamber for processing, cassettes 27, 28 are loaded with wafers 18 and positioned as shown in FIG. 1, with the wafer slots facing toward transfer mechanism 29. Access door 14 is opened, and utilizing transfer mechanism 29 ali or a portion of the wafers are transferred from one of the cassettes to staging station 16.

The wafers are removed from the cassette by rotating carriage 32 and extending slide 34 to position paddles 37 beneath the wafers. The paddles are then raised relative to the cassette, and the slide is retracted to withdraw the wafers from the cassette.

Carriage 32 is then rotated into alignment with staging station 16, and slide 34 is extended to position the wafers above the shelves 19 of the staging station. The wafers are then transferred onto the shelves, either by lowering the paddles or by raising the staging station, following which the slide is retracted to withdraw the paddles, and access door 14 is closed to seal the chamber.

Wafers are transferred between staging station 16 and processing stations A - D by turret 17. The wafers are picked up from the staging station and carried to the processing stations by wafer carriers 23 with their fingers 24 in the closed position and the wafers resting on tabs 26. The wafers are lifted off the staging station shelves 19 either by raising the turret arms 17 or by lowering the staging station. When the wafers are returned to the staging station, they are placed back on the shelves by setting the wafers down on the shelves and opening the fingers to release them.

The turret can transfer a wafer to or from any shelf in the staging station simply by raising or lowering the turret to position the wafer carrier at the proper level for the shelf. Thus, the wafers can be processed in any order desired, including random order or a predetermined sequence.

After processing, wafers are transferred back to the cassettes by returning them to staging station 16, opening access door 14, lifting the wafers off the staging station shelves 19 with transfer mechanism 29, and transferring them to one of the cassettes with that mechanism.

In the event that the spacings between cassette slots and the staging station shelves are not the same, the spacing between the wafers can be either increased or decreased as needed while the wafers are being transferred between the staging station and the cassettes.

The embodiments of FIGS. 20 - 29 are generally similar to the embodiment of FIG. 1, and like reference numerals designate corresponding elements in the different embodiments.

The embodiment shown in FIG. 20 has four cassettes 81 - 85 arranged in a straight line facing vacuum chamber 11, and the carriage 32 of transfer mechanism 29 is mounted on a track or way 87 for movement along a line parallel to the cassettes.

In this embodiment, wafers can be transferred to or from any of the four cassettes by moving carriage 32 along the track until it is directly in front of the desired cassette, then rotating the carriage and extending slide 34 to position paddles 37 in the cassette. If wafers are being delivered to the cassette, the paddles are then lowered to disengage them from the wafers. If wafers are being removed from the cassette, the paddles are raised into engagement with the wafers and withdrawn with the wafers resting on them. Wafers are delivered to the staging station 16 by moving the carriage along the track and rotating it to bring it into alignment with staging station, following which the slide is extended and then lowered to place the wafers on the shelves 19 in the staging station.

The embodiment of FIG. 22 has a robot 89 with articulating arms for transferring wafers between cassettes 27, 28 and staging station 16. This robot has a first arm 91 which is mounted on a shaft 92 that can be rotated about and translated along its axis. That axis is positioned centrally between the staging station and the cassettes, and the cassettes are oriented to face the axis. A second arm 93 is pivotally connected to arm 91, and a stack of wafer carrying paddles 94 extend from a post which is pivotally connected to arm 93. Although the paddles are illustrated as being similar to paddles 37, they can be of any suitable type, including all of the embodiments shown in FIGS. 10 - 17. The paddles can engaged with and disengaged from wafers in the cassettes and the staging station by raising and lowering shaft 92.

Operation and use of this embodiment is similar to that of the embodiment of FIG. 1 except that the paddles are positioned within the cassettes and the staging station by manipulation of the articulating arms.

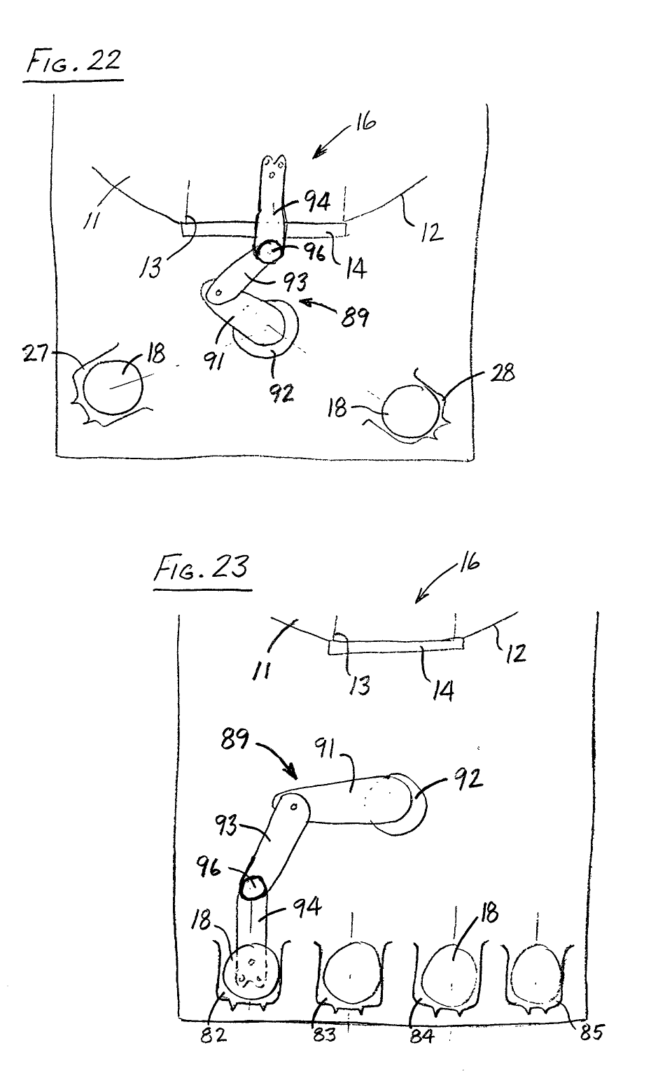

The embodiment of FIG. 23 is similar to the embodiment of FIG. 20 except that it has a robot 89 with articulating arms instead of transfer mechanism 29 for transferring wafers between cassettes 82 - 85 and staging station 16. By manipulation of the arms, the wafer carrying paddles can be moved between any of the cassettes and the staging station.

In the embodiment of FIG. 25, a plurality of cassettes 93 - 96 are mounted side-by-side on a carriage 97 which can be translated laterally of vacuum chamber 11 to bring any one of the cassettes into a transfer position in alignment with access opening 13 and staging station 16. Thus, for example, in FIG. 25, cassette 94 is shown in the transfer position, and in FIG. 26, cassette 93 is shown in that position.

A pusher mechanism 98 is located at the transfer station for transferring wafers from the cassettes to the staging station. This mechanism includes an upright pusher bar 99 mounted on a carriage 101 for movement between a retracted position shown in full lines in FIG. 27 and an extended position which is shown in phantom lines.

In operation, one of the cassettes is brought into the transfer position by movement of carriage 97, and the pusher mechanism is extended, with pusher bar 99 pushing the wafers from the cassette through access opening 13 to staging station 16.

The embodiment of FIG. 28 also has a plurality of cassettes 93 - 96 mounted side-by-side on a carriage 97 as in the embodiment of FIG. 25. However, in this embodiment, the wafers are transferred between the cassettes and staging station 16 by a robot 103 which is positioned between the cassettes and the access opening 13 of the vacuum chamber. This robot has an arm 104 affixed to a shaft which can be rotated about and translated along its axis, and a stack of wafer carrying paddles 107 extending from a post 108 which is pivotally mounted on the arm.

As in the embodiment of FIG. 25, one of the cassettes is positioned in alignment with access opening 13 by translation of carriage 97. Wafers can then be transferred between that cassette and transfer station 16 by manipulation of arm 104 and paddles 107.

FIG. 30 illustrates another embodiment of a staging station which is generally similar to the embodiment of FIG. 3, with like reference numerals designating corresponding elements in the two embodiments.

As in the other embodiments, the inner ends of wafer carrying fingers 24 are attached to the outer ends of the turret arms by pivots 41. An actuator 111 is positioned between the fingers for moving them between the open and closed positions, and a latch 112 retains the fingers in the desired position.

The staging station shelves in this embodiment are generally circular disks 113, with mounting tabs 114. Each disk has a cut-out area 116 for receiving paddles 37, and peripheral notches 117 for receiving the tabs 26 on fingers 24. As in the other embodiments, wafer carriers 23 and paddles 37 can be moved vertically with respect to the staging station shelves in order to place wafers on and remove wafers from those shelves.

A preferred sequence for processing wafers in accordance with the invention is illustrated in FIG. 31. As noted above, the number of shelves in the staging station is preferably at least the number of wafers in a cassette plus the number of processing stations. In this particular example, it is assumed that there are 25 slots in each cassette, four processing, and 29 shelves in the staging station.

At the start of the process, wafers 1 - 25 are in the top 25 shelves of the staging station, and processing stations A - D are all empty. On its first step, the turret transfers the wafer 1 from the top shelf of the staging station (wafer 1) to processing station A. On the second step, that wafer is transferred to processing station B, and the next wafer (wafer 2) is transferred to processing station A. This sequence continues, and on each step, the uppermost wafer in the staging station transferred to processing station A and the wafers which are already in processing stations are transferred to the next station.

After a wafer has been in all four of the processing stations, it is returned to the staging station. On each rotational step, the turret also steps down one shelf, so that when a wafer is returned to the staging station, it is placed on the shelf four shelves below the one where it was when the process began. Thus, for example, when wafer 1 returns to the staging station, it is placed on shelf 5. This also means that as long as wafers are being transferred out of the staging station, the returning wafer is placed on the shelf being vacated by the departing wafer. At the end of the process, wafers I - 25 will be on shelves 5 - 29, shelves 1 - 4 will be empty, and the four processing stations will also be empty.

The embodiment illustrated in FIGS. 32 - 33 includes a load lock 119 through which wafers are transferred into and out of vacuum chamber 11. The load lock is positioned above the top wall 121 of the chamber, and staging station 16 is mounted on an elevator 122 for movement between the vacuum chamber and the load lock through an opening 123 in the top wall. An isolation door 124 is mounted on the elevator below the staging station and serves as a closure for the opening when the staging station is in the load lock. An O-ring 126 provides a seal between the chamber wall and the door.

The load lock also has an exterior access opening 128 through which the wafers pass as they are being are transferred between cassette 27 and staging station 16 by wafer loader or transfer mechanism 29. An access door 129 is provided for closing that opening when the staging station is in its lower position and opening 123 is open. This maintains the vacuum within chamber 11 as wafers are transferred into and out of it.

Operation and use of the embodiment of FIGS. 32 - 33 is as follows. Wafers are transferred from the cassette to the staging station when the staging station is positioned in the load lock, with a isolation door 124 sealing the opening between the load lock and the vacuum chamber. Access door 129 is opened, and wafers are transferred from the cassette to the staging station by wafer loader 29. As in the other embodiments, any or all of the wafers in the cassette can be transferred at once.

After the wafers have been transferred to the staging station, access door 129 is closed, and the staging station is lowered into the vacuum chamber, with isolation door 126 moving away from opening 123 with the staging station. Turret 17 then transfers the wafers between the staging station and the processing stations, returning them to the staging station when the processing is completed.

The wafers are transferred back to the cassette by raising the staging station up into the load lock. When the staging station reaches the end of its travel, isolation door 124 seats against under side of top wall 121, once again sealing the opening between the vacuum chamber and the load lock. Access door 129 is then opened, and wafer loader 29 transfers the wafers from the staging station to the cassette.

The invention has a number of important features and advantages. It has a single vacuum processing chamber with multiple processing stations. With a multiple-wafer staging station within the processing chamber and the ability to transfer multiple wafers to and from it, the amount of time the access door must remain open to transfer wafers into and out of the chamber is minimized, thereby eliminating the need for a separate load lock. Wafers are transferred between the staging station and the processing station by a simple lift and rotate mechanism, rather than an expensive vacuum robot, which improves the reliability of the system.

Wafers can be processed in either random or sequential fashion without changing the hardware setup, which minimizes process setup and change-over time and maximizes equipment uptime. A number of different processing sequences can be employed, including batch processing, sequential processing and flexible processing in which the sequence can be changed without changing the hardware at the processing stations within the vacuum chamber, thereby avoiding the need for costly equipment shutdowns.

In a number of embodiments, the load lock is integrated with the vacuum chamber, eliminating the need for an expensive vacuum robot between the load lock and the vacuum chamber. Only one relatively inexpensive atmospheric wafer transfer mechanism or robot is required.

The equipment is relatively uncomplex and can be manufactured and maintained at low cost. The equipment has a relatively small footprint and a low cost of ownership.

With the use of a low duty, low cost, multiple-wafer handling atmospheric robot between the cassette station and the load lock, throughput is maximized, and a bottleneck at the robot is avoided. Multiple wafers can be transferred simultaneously between the cassettes and the staging station, typically 12, 25, 26 or 50 wafers at a time. Within the processing chamber, wafers can be simultaneously loaded and uloaded between the staging station and the processing stations.

The apparatus can handle wafers of any desired size, including 200 mm and 300 mm wafers, and conversion between the different sizes is easy.

The staging station and turret can be magnetically coupled with drive mechanisms which are located outside the chamber walls, thus maintaining a clean processing environment within the chamber with no sliding surfaces to generate particles.

As the wafers are being transferred into and out of the processing chamber, the spacing between them can be increased or decreased to accommodate different spacings between the slots of the cassettes and the shelves of the staging station.

Where a separate load lock is employed, moving the staging station between the load lock and the vacuum chamber and sealing the opening between the two with a simple isolation door carried by the staging station eliminates the need for a complex load lock door and provides an effective seal between the load lock and the vacuum chamber.

It is apparent from the foregoing that a new and improved method and apparatus for processing semiconductor wafers have been provided. While only certain presently preferred embodiments have been described in detail, as will be apparent to those familiar with the art, certain changes and modifications can be made without departing from the scope of the invention as defined by the following claims.

1. Apparatus for processing semiconductor wafers, comprising: a vacuum chamber having an access opening with a door, a processing station within the chamber, a wafer staging station within the chamber near the access opening, means for transferring wafers between the staging station and the processing station, a cassette positioned outside the chamber, and means located outside the chamber for transferring wafers between the cassette and the staging station through the access opening.

2. The apparatus of claim 1 wherein the means for transferring wafers between the staging station and the processing station comprises a rotating turret.

3. The apparatus of claim 1 wherein the staging station has a plurality of shelves for holding wafers, and the means for transferring wafers from between the cassette and the staging station includes means for simultaneously transferring a plurality of wafers to or from the shelves.

4. A method of processing semiconductor wafers in a vacuum chamber, comprising the steps of: storing a plurality of wafers in a cassette outside the chamber, transferring wafers between the cassette and a staging station inside the chamber with a transfer mechanism located outside the chamber, and transferring wafers between the staging station and a processing station within the chamber with a transfer mechanism located inside the chamber.

5. The method of claim 4 wherein the wafers are transferred between the staging station and the processing station by a rotating turret.

6. The method of claim 4 wherein a plurality of wafers are simultaneously transferred between the cassette and the staging station.

7. Apparatus for processing semiconductor wafers, comprising: a vacuum chamber, a plurality of processing stations within the chamber, a wafer staging station within the chamber, means for transferring wafers between the staging station and the processing stations, a cassette positioned outside the chamber, and means located outside the chamber for transferring wafers between the cassette and the staging station.

8. The apparatus of claim 7 wherein the staging station and the processing stations are all disposed along a circular path within the chamber, and the means for transferring wafers between the staging station and the processing stations comprises a rotating turret having a plurality of radially extending arms for carrying the wafers between the stations.

9. The apparatus of claim 8 wherein the staging station has a plurality of spaced shelves for holding the wafers, and the turret and the shelves are movable axially of each other for transferring wafers to or from different ones of the shelves.

10. A method of processing semiconductor wafers in a vacuum chamber, comprising the steps of: storing a plurality of wafers in a cassette outside the chamber, transferring wafers between the cassette and a staging station inside the chamber with a transfer mechanism located outside the chamber, and transferring wafers between the staging station and a plurality of processing stations within the chamber with a transfer mechanism located inside the chamber.

11. The method of claim 10 wherein the wafers are transferred between the staging station and the processing stations by a rotating turret having a plurality of radially extending arms which carry the wafers.

12. The method of claim 10 including the step of moving the staging station and the turret axially of each other to align the turret arms with different wafer holding shelves in the staging station.

13. Apparatus for processing semiconductor wafers, comprising: a vacuum chamber, a processing station within the chamber, a wafer staging station within the chamber, means for transferring wafers between the staging station and the processing station, a plurality of cassettes positioned outside the chamber, and means located outside the chamber for transferring wafers between the cassettes and the staging station.

14. The apparatus of claim 13 wherein the cassettes face generally toward each other, and the means for transferring wafers between the cassettes and the staging station comprises a rotatively and translatively movable carriage and a plurality of paddles mounted on the carriage for carrying the wafers.

15. The apparatus of claim 13 wherein the cassettes are disposed along a line facing the chamber, and the means for transferring the wafers between the cassettes and the staging station comprises a carriage which can be rotated and translated in a direction parallel to the cassettes, an extendable and retractable slide mounted on the carriage, and a plurality of paddles carried by the slide for carrying the wafers.

16. The apparatus of claim 13 wherein the cassettes face toward a central axis, and the means for transferring wafers between the cassettes and the staging station comprises a first arm which is rotatable about the central axis, a second arm pivotally connected to the first arm, and a plurality of paddles pivotally connected to the second arm for carrying the wafers.

17. The apparatus of claim 13 wherein the cassettes are disposed along a line facing generally toward the chamber, and the means for transferring wafers between the cassettes and the staging station comprises a first arm which is rotatable about a central axis, a second arm pivotally connected to the first arm, and a plurality of paddles pivotally connected to the second arm for carrying the wafers.

18. The apparatus of claim 13 wherein the cassettes are mounted side-by-side on a carriage which can be translated laterally of the chamber to position different ones of the cassettes in alignment with an access opening for the chamber, and the means for transferring wafers between the cassettes and the staging station comprises a pusher for advancing wafers from a cassette aligned with the opening to the staging station.

19. The apparatus of claim 13 wherein the cassettes are mounted side-by-side on a carriage which can be translated laterally of the chamber to position different ones of the cassettes in alignment with an access opening for the chamber, and the means for transferring wafers between the cassettes and the staging station comprises an arm which can be rotated about an axis located between the cassettes and the chamber, and a plurality of paddles carried by the arm for carrying wafers from a cassette aligned with the opening to the staging station.

20. A method of processing semiconductor wafers in a vacuum chamber, comprising the steps of: storing wafers in a plurality of cassettes outside the chamber, transferring wafers between the cassettes and a staging station inside the chamber with a transfer mechanism located outside the chamber, and transferring wafers between the staging station and a processing station within the chamber with a transfer mechanism located inside the chamber.

21. The method of claim 20 wherein the cassettes are positioned so that they face generally toward each other, and the wafers are transferred between the cassettes and the staging station by engaging the wafers with paddles mounted on a carriage, and rotating and translating the carriage to move the wafers between the cassettes and the staging station.

22. The method of claim 20 wherein the cassettes are positioned along a line facing the chamber, and the wafers are transferred between the cassettes and the staging station by translating a carriage in a direction parallel to the cassettes, rotating the carriage to align a slide carried by the carriage with the cassettes and the staging station, and extending and retracting the slide to deliver the wafers to and from the cassettes and the staging station.

23. The method of claim 20 wherein the cassettes are positioned to face toward a central axis, and the wafers are transferred between the cassettes and the staging station by manipulation of a first arm which can be rotated about the central axis, a second arm which is pivotally connected to the first arm, and a plurality of wafer carrying paddles which are pivotally connected to the second arm.

24. The method of claim 20 wherein the cassettes are disposed along a line facing generally toward the chamber, and the wafers are transferred between the cassettes and the staging station by manipulation of a first arm which can be rotated about a central axis, a second arm which is pivotally connected to the first arm, and a plurality of wafer carrying paddles which are pivotally connected to the second arm.

25. The method of claim 20 wherein the cassettes are mounted side-by-side on a carriage, and the wafers are transferred between the cassettes and the staging station by translating the carriage laterally of the chamber to position different ones of the cassettes in alignment with an access opening for the chamber, and pushing wafers from a cassette aligned with the opening to the staging station.

26. The method of claim 20 wherein the cassettes are mounted side-by-side on a carriage, and the wafers are transferred between the cassettes and with the staging station by translating the carriage laterally of the chamber to position different ones of the cassettes in alignment with an access opening for the chamber, pivoting an arm about a stationary axis located between the cassettes and the chamber, and pivoting a plurality of wafer carrying paddles carried by the arm about a swinging axis which is parallel to the stationary axis.

27. Apparatus for processing semiconductor wafers, comprising: a vacuum chamber, a processing station within the chamber, a wafer staging station having a plurality of spaced apart shelves for holding wafers within the chamber, means for transferring wafers between the staging station and the processing station, a cassette having a plurality of spaced apart slots for holding wafers outside the chamber, a wafer transport mechanism having a stack of wafer carriers for transferring wafers between the cassette and the staging station, and means for changing the spacing between the wafer carriers to match the spacings between the shelves in the staging station and the slots in the cassette.

28. The apparatus of claim 27 wherein the means for changing the spacing between the wafer carriers comprises a scissor mechanism.

29. A method of processing semiconductor wafers in a vacuum chamber, comprising the steps of: storing wafers in spaced apart slots in a plurality of cassettes outside the chamber, transferring wafers between the cassettes and the shelves of a staging station inside the chamber with a transfer mechanism having a stack of wafer carriers, changing the spacing between the wafer carriers as the wafers are being transferred to match the spacing between the shelves or the slots to which the wafers are going, and transferring wafers between the staging station and processing stations within the chamber with a transfer mechanism located inside the chamber.

30. Apparatus for processing semiconductor wafers, comprising: a vacuum chamber, a staging station having a plurality of wafer holding shelves and a plurality of processing stations disposed along a circular path within the chamber, an axially positionable rotating turret with radially extending arms for transferring wafers between the shelves of the staging station and the processing stations, a plurality of cassettes each having a plurality of slots for receiving wafers outside the chamber, and means for simultaneously transferring a plurality of wafers between the cassettes and the staging station.

31. The apparatus of claim 30 wherein the means for transferring the wafers between the cassettes and the staging station includes a stack of wafer carriers and means for changing the spacing between the carriers to accommodate different spacings between the shelves of the staging station and the slots in the cassettes.

32. A method of processing semiconductor wafers in a vacuum chamber, comprising the steps of: storing wafers in slots in a plurality of cassettes outside the chamber, simultaneously transferring a plurality wafers between one of the cassettes and the shelves of a staging station inside the chamber, and transferring wafers between the staging station and a plurality of processing stations within the chamber by axially adjusting the position of a rotary turret to bring the arms of the turret into alignment with different ones of the shelves in the staging station, and rotating the turret to move wafers carried by the arms to different ones of the stations.

33. The method of claim 32 including the step of changing the spacing between the wafers as they are being transferred between the cassette and the staging station to match the spacing of the slots or the shelves to which they are being transferred.

34. Apparatus for processing semiconductor wafers, comprising: a vacuum chamber, a processing station within the chamber, a load lock having an access door which opens to the atmosphere and an opening which communicates with the vacuum chamber, a wafer staging station which is movable through the vacuum opening between the load lock and the vacuum chamber, means for transferring wafers between the staging station and the processing station when the staging station is in the vacuum chamber, a cassette positioned outside the chamber, means for transferring wafers through the access door between the cassette and the staging station when the staging is in the load lock, and a closure which moves with the staging station for sealing the vacuum opening when the staging station is in the load lock.

35. A method of processing semiconductor wafers in a vacuum chamber with a load lock, an access door providing external access to the load lock, and an opening between the load lock and the vacuum chamber, comprising the steps of: positioning a staging station in the load lock, with a closure carried by the staging station sealing the opening between the load lock and the vacuum chamber, opening the access door, transferring wafers from a cassette located outside the load lock through the open door to the staging station, closing the access door, moving the staging station through the opening from the load lock to the vacuum chamber, with the closure moving away from the opening with the staging station, and transferring wafers between the staging station and a processing station within the vacuum chamber while the staging station is in the chamber.

36. A method of processing semiconductor wafers in a vacuum chamber with a load lock, an access door providing external access to the load lock, and an opening between the load lock and the vacuum chamber, comprising the steps of: positioning a staging station in the vacuum chamber, transferring wafers between the staging station and a processing station within the vacuum chamber, moving the staging station through the opening from the vacuum chamber to the load lock, with a closure carried by the staging station sealing the opening between the load lock and the vacuum chamber, opening the access door, and transferring wafers from the staging station through the open door to a cassette located outside the load lock and the vacuum chamber.
